(19) United States
(12) Patent Application Publication
(10) Pub. No.: US 2013/0265366 A1
(43) Pub. Date: Oct. 10, 2013

(54) LIQUID EJECTING APPARATUS

(71) Applicant: SEIKO EPSON CORPORATION, Tokyo (JP)

(72) Inventors: Masato Murayama, Matsumoto-shi (JP); Chikashi Nakamura, Azumino-shi (JP); Hiroyuki Kobayashi, Azumino-shi (JP)

(73) Assignee: SEIKO EPSON CORPORATION, Tokyo (JP)

(21) Appl. No.: 13/850,948

(22) Filed: Mar. 26, 2013

(30) Foreign Application Priority Data
Apr. 10, 2012 (JP) 2012-089243

(51) Int. Cl. B41J 2/165

(52) U.S. Cl. CPC B41J 2/16535
USPC 347/33

(57) ABSTRACT

A liquid ejecting apparatus includes a liquid ejecting head on which a liquid ejecting nozzle is provided; and a wiping section which wipes the liquid ejecting head by relative moving a liquid absorption body which absorbs the liquid while abutting the liquid absorption body to the liquid ejecting head, wherein the liquid ejecting head has a surface constituted of first region surface on which the nozzle is formed and a second region surface which is continuous to the first region surface with a step, as a wiping surface which is wiped by the wiping section, and wherein on the wiping surface, the second region surface is a surface having lower liquid-repellency than the first region surface with respect to the liquid.

The entire disclosure of Japanese Patent Application No: 2012-089243, filed Apr. 10, 2012 is expressly incorporated by reference herein in its entirety.

### BACKGROUND

1. Technical Field

The present invention relates to a liquid ejecting apparatus and, more particularly, to a wiping technique of liquid attached to a liquid ejecting head.

2. Related Art

In the related art, as a type of a liquid ejecting apparatus, an ink jet type printer has been known in which an image is formed by ejecting the liquid from a nozzle formed on a liquid ejecting head onto a medium such as a paper. Usually, in such a printer, a maintenance device is provided to maintain ejection characteristics of the liquid from the nozzle.

For example, as the maintenance device of such a type, a wiping section, which wipes the liquid attached to the nozzle forming surface on which the nozzle is formed, is provided on the liquid ejecting head. The wiping section usually has a rubber wiper formed from a rubber material such as elastomer. In addition, the wiping section wipes the liquid in such a manner that the rubber wiper captures and removes from the nozzle forming surface the liquid attached to the nozzle forming surface by moving the rubber wiper while abutting the nozzle forming surface of the liquid ejecting head.

Then, in the related art, when the liquid is ejected from the nozzle, for example, as disclosed in JP-A-2011-778, liquid-repellent treatment is performed on a region, that is, a nozzle forming surface which the rubber wiper (the wiping member) comes into contact with to form a liquid-repellent film thereon when the wiping is performed so that the liquid is hardly attached to the nozzle forming surface and is easily separated from the nozzle forming surface.

In addition, a head cover is provided on a portion which is a periphery of the nozzle forming surface and an object thereof is to protect the liquid ejecting head so that the rubber wiper smoothly abuts the liquid ejecting head when the rubber wiper abuts the liquid ejecting head. The head cover covers a side surface of the liquid ejecting head and covers a square-annular surface region along a peripheral circumstance on the nozzle forming surface. Thus, a surface (hereinafter, referred to as “a covered region surface”) of a portion of the head cover which covers the square-annular surface region of the nozzle forming surface is also a wiping surface on which the rubber wiper is abutted and moved, similar to the nozzle forming surface. Accordingly, as disclosed in JP-A-2011-778, the liquid-repellent treatment is also performed on the surface of the head cover.

However, a step corresponding to a thickness of the head cover is formed between the covered region surface of the head cover which covers the square-annular surface region of the nozzle forming surface which is the wiping surface and the nozzle forming surface. Accordingly, in the wiping surface, a region surface having liquid-repellency exists on both sides of the step portion. Thus, the liquid moved from such a region surface having the liquid-repellency to the step portion and the liquid is likely to remain in the step portion. However, since the rubber wiper does not reach the step portion, the liquid remained on the step portion may not be captured by the rubber wiper. As a result, the liquid remained on the step portion without being captured is solidified and accumulated. Accordingly, for example, the abutment of the cap which abuts the nozzle forming surface may be interfered when the liquid is sucked from the nozzle. Otherwise, the accumulated and solidified liquid falls on a medium and quality of the image which is formed on the medium may be degraded.

Then, it is conceivable that the liquid attached to the wiping surface having the step is removed by a method in which the liquid is absorbed when wiping is performed by a liquid absorption body capable of absorbing the liquid instead of the wiping method using the rubber wiper. However, since the liquid is in a liquid droplets state on the wiping surface on which the liquid-repellent treatment is performed, the liquid is concentrated and absorbed in order to a portion of the surface of the liquid absorption body. Thus, when the wiping surface is wiped with the moving liquid absorption body, the absorption of the liquid from the wiping surface side to the liquid absorption body may not be enough depending on the number or a size (an amount of the liquid) of the liquid droplets existing on the wiping surface. As a result, the liquid attached to the wiping surface is moved on the wiping surface and attracted on the step portion of the wiping surface, and remained on the wiping surface without being absorbed into the liquid absorption body. Accordingly, the liquid is concentrated on the step portion. Thus, the liquid concentrated on the step portion, is not absorbed enough into the liquid absorption body and then the liquid remains on the wiping surface (the step portion) even though the liquid absorption body is used, similar to the rubber wiper.

In addition, such a situation is generally common in a liquid ejecting apparatus including a wiping section which wipes a liquid ejecting head by relative moving the liquid absorption body absorbing the liquid while abutting the wiping surface which has the step in the liquid ejecting head, as well as in the ink jet type printer.

### SUMMARY

An advantage of some aspects of the invention is to provided a liquid ejecting apparatus which is capable of absorbing liquid attached to a wiping surface of a liquid ejecting head having a step in a liquid absorption body without being remained on the wiping surface when the wiping surface is wiped by the liquid absorption body.

According to an aspect of the invention, there is provided a liquid ejecting apparatus including: a liquid ejecting head on which a liquid ejecting nozzle is provided; and a wiping section which wipes the liquid ejecting head by relative moving a liquid absorption body which absorbs the liquid while abutting the liquid absorption body to the liquid ejecting head, wherein the liquid ejecting head has a surface constituted of first region surface on which the nozzle is formed and a second region surface which is continuous to the first region surface with a step, as a wiping surface which is wiped by the wiping section, and wherein on the wiping surface, the second region surface is a surface having lower liquid-repellency, than the first region surface with respect to the liquid.

In this case, since the second region surface has the low liquid-repellency, the liquid attached to the step portion by moving from the first region surface when the wiping is performed is moved from the first region surface to the second region surface without being concentrated and remained on the step portion. In addition, the liquid attached to on the second region surface including the liquid which is moved from the first region surface side is spread on the entire second region surface without being concentrated on a portion thereof. As a result, in the wiping section, the liquid which is spread on the second region surface can be absorbed from the wiping surface including the step portion of the wiping surface without being remained by the liquid absorption body which is moved while wiping the wiping surface.

According to the aspect, the second region surface may be a concave surface which protrudes from the first region surface to the liquid absorption body side abutting when the wiping is performed.

In this case, the second region surface is close to the liquid absorption body. Thus, when the wiping is performed by the liquid absorption body, the second region surface is reliably wiped from the first region surface by the liquid absorption body. Accordingly, the liquid attached to the second region surface having the low liquid-repellency including the liquid which is moved from the first region surface can be efficiently absorbed into the liquid absorption body.

According to the aspect, the liquid ejecting apparatus may further include a head cover which covers at least a portion of the wiping surface of the liquid ejecting head, wherein the second region surface constituting the wiping surface may be a surface of the head cover.

In this case, the surface of the head cover is a surface having the liquid-repellency lower than the first region surface so that the second region surface constituting the wiping surface can easily be a surface having the liquid-repellency lower than the first region surface.

According to the aspect, the second region surface may be formed so as to surround the first region surface.

In this case, the wiping section can move the liquid attached to the first region surface to the second region surface regardless of the moving direction of the liquid absorption body which is relatively moved.

According to the aspect, the liquid absorption body may be formed of a fiber-based member.

In this case, the liquid can be absorbed into a space portion having the fiber. Thus, the liquid attached to the wiping surface including the step portion can be efficiently absorbed.

### BRIEF DESCRIPTION OF THE DRAWINGS

The invention will be described with reference to the accompanying drawings, wherein like numbers reference like elements.

FIG. 1 is a schematic constitution view of a printer which is an embodiment of a liquid ejecting apparatus according to the invention.

FIG. 2 is a schematic diagram illustrating a constitution of a wiper cassette in the printer of the embodiment.

FIGS. 3A and 3B are schematic diagrams illustrating a liquid ejecting head, a head cover and a liquid absorption body, FIG. 3A is a bottom view thereof and FIG. 3B is a side view including an end surface along a line IIB-IIIB in FIG. 3A.

FIGS. 4A to 4C are schematic diagrams illustrating a wiping state by the liquid absorption body in Comparative Example, FIG. 4A is a bottom view thereof, FIG. 4B is a side view including the end surface viewed from an arrow line IVB-IVB in FIG. 4A and FIG. 4C is a bottom view illustrating a wiping surface after the wiping is performed.

FIGS. 5A to 5C are schematic diagrams illustrating the wiping state by the liquid absorption body in the embodiment, FIG. 5A is a plan view thereof, FIG. 5B is a side view including the end surface viewed from an arrow line VB-VB in FIG. 5A and FIG. 5C is a bottom view illustrating a wiping surface after the wiping is performed.

FIGS. 6A to 6C are schematic diagrams illustrating Modification Examples of the wiping surface having a step, respectively.

### DESCRIPTION OF EXEMPLARY EMBODIMENTS

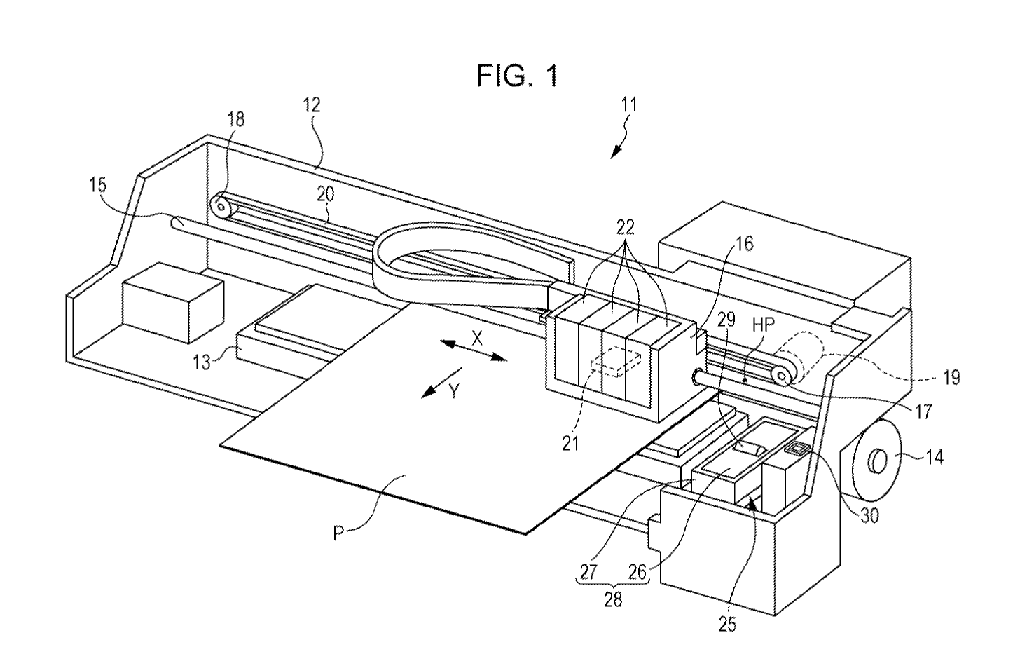

Hereinafter, an embodiment in which a liquid ejecting apparatus of the invention is embodied in an ink jet type printer (hereinafter, may be referred to as “a printer”) is described with reference to FIGS. 1, 2, 3A and 3B.

As illustrated in FIG. 1, in the printer 11, a support member 13 is provided in a state where a longitudinal direction thereof is in accord with a main scanning direction X in a lower portion which is a direction of gravity inside a frame 12 having a substantially rectangular-box shape. A paper P is fed on the support member 13 in a sub-scanning direction Y crossing the main scanning direction X, based on a driving of a paper feeding motor 14 provided on the lower portion of rear surface of the frame 12. In addition, a rod-shaped guide shaft 15 extending in parallel with the longitudinal direction of the support member 13 is provided on an upper portion of the support member 13 inside the frame 12. A carriage 16 is supported on the guide shaft 15 in a state of being able to reciprocate in the axial direction thereof.

A driving pulley 17 and a driven pulley 18 are rotatably supported on each position corresponding to both end portions of the guide shaft 15 in the inner surface of a wall portion of the rear surface side of the frame 12. An output shaft of a carriage motor 19 that is a driving source when the carriage 16 is reciprocated is connected to the driving pulley 17. In addition, an endless timing belt 20 a portion of which is connected to the carriage 16 is hung between the pair of the pulleys 17 and 18. Accordingly, the carriage 16 is able to move in the main scanning direction X via the endless timing belt 20 by the driving force of the carriage motor 19 while being guided by the guide shaft 15.

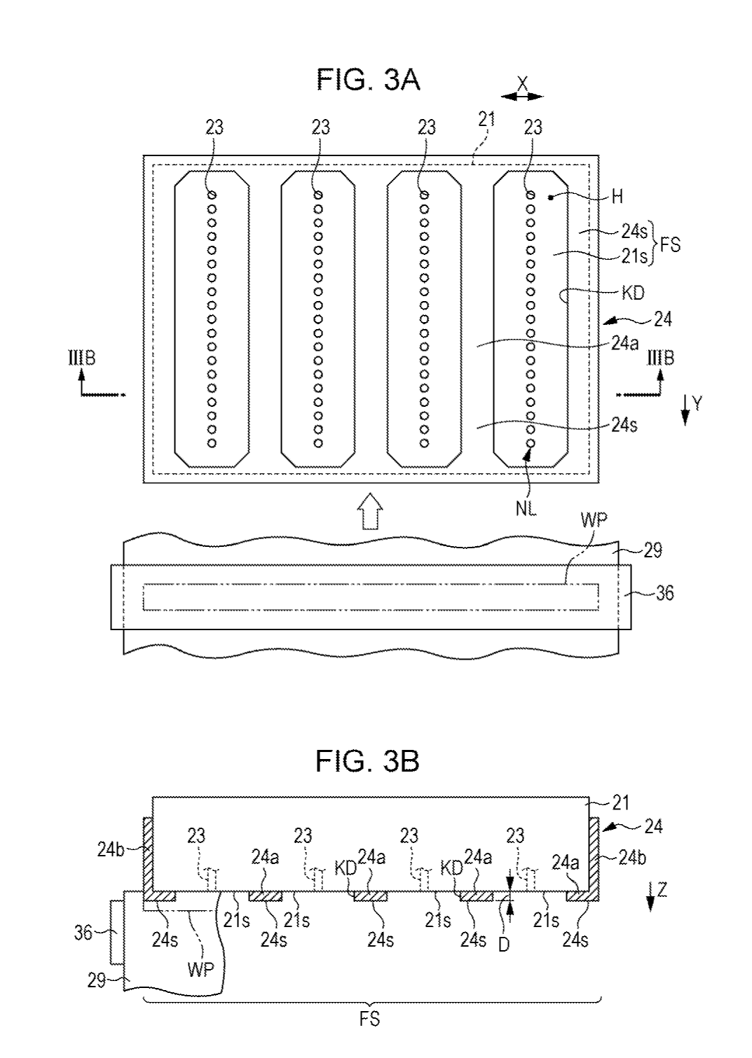

A liquid ejecting head 21 is provided on the lower surface side facing the support member 13 in the carriage 16. Meanwhile, a plurality (four, in the embodiment) of cartridges 22 storing the ink (the liquid) which is supplied to the liquid ejecting head 21, are detachably mounted on the carriage 16. In the embodiment, color inks of cyan, magenta, yellow and black are stored in four cartridges 22, respectively. Then, the liquid ejecting head 21 forms an image or the like on the paper P by ejecting the ink from a nozzle 23 (see, FIG. 3A) formed on the lower surface thereof, which is supplied from the ink cartridge 22 onto the paper P fed on the support member 13.

In addition, as illustrated in FIG. 1, a maintenance device 25 is provided on a home position HP which is provided on a position outside from a region in which the paper P is transported inside the frame 12 to perform maintenance of the liquid ejecting head 21.

The maintenance device 25 includes the wiper cassette 26, a wiper holder 27 on which the wiper cassette 26 is detachably mounted, a wiper unit 28 as a wiping section having a driving mechanism (not illustrated) which moves the wiper holder 27 relative to the liquid ejecting head 21. In addition, maintenance device 25 includes a cap 30 abutting the liquid ejecting head 21 to surround the nozzle 23 and a pump (not illustrated) which is driven for sucking and discharging a waste ink from the nozzle 23 of the liquid ejecting head 21 via the cap 30.

The wiper cassette 26 is mounted on the wiper unit 28 of the embodiment, which is formed of a fiber-based member such as yarn or fabric material of which is natural fiber and chemical fiber. The wiper member 29 as a liquid absorption body absorbs the ink attached to a surface on which the nozzle 23 is formed by abutting the lower surface of the liquid ejecting head 21. Then, the wiper unit 28 is constituted to wipe the lower surface of the liquid ejecting head 21 by moving the wiping member 29 relatively to the liquid ejecting head 21. In addition, in the embodiment, wiper unit 28 reciprocates along the sub-scanning direction Y across the main scanning direction X.

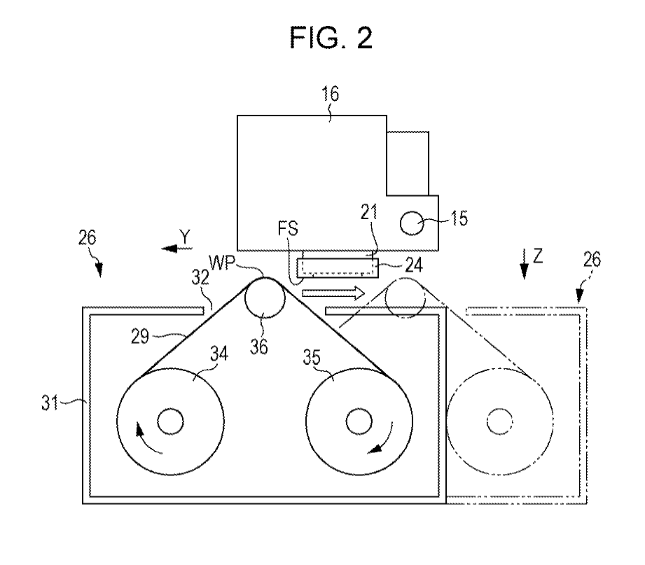

However, in the embodiment, although not illustrated in FIG. 1, a head cover 24 (see, FIG. 2) is included in the liquid ejecting head 21 to cover an entire periphery of the side surface of the liquid ejecting head 21 and a surface of at least a portion of the lower surface thereof, as one purpose to protect the liquid ejecting head 21 so that the wiping member 29 smoothly abuts the liquid ejecting head 21 when the wiping is performed. Accordingly, the wiping member 29 has a constitution to wipe both the lower surface of the liquid ejecting head 21 and the lower surface of the head cover 24 on a wiping surface FS (see, FIG. 2) by moving relatively to the liquid ejecting head 21.

Next, a constitution about the wiping of the wiping member 29 is deformed with reference to FIG. 2.

As illustrated in FIG. 2, a pair of the rollers 34 and 35 having an axis extending substantially horizontally in a direction across the moving direction of the wiper cassette 26, in other words, a direction across a direction along the sub-scanning direction Y are stored in a substantially rectangular-box shaped case body 31 which constitutes an exterior of the wiper cassette 26. The long wiping member 29 having a width dimension corresponding to the entire region opening the lower surface of the head cover 24 is hung between the pair of the rollers 34 and 35. Then, one roller (here, the roller 34) of the pair of the rollers 34 and 35 functions as a feeding roller from which an unused and wound wiping member 29 is fed. In addition, the other roller (here, the roller 35) in the pair of the rollers 34 and 35 functions as a winding roller to which a used wiping member 29 which is wiped in the wiping member released and wound from the winding roller.

In addition, in the case body 31, a roller 36 is provided on a feeding path of the wiping member 29 from the roller 34 to the roller 35. The roller 36 is extended in parallel with the roller 34 and the roller 35, and is rotatably supported by a bearing portion or the like of which both ends in the axial direction are provided on the case body 31. In addition, the roller 36 is biased upward in vertical direction opposite the gravity direction Z side by biasing both ends thereof in the axial direction using a biasing spring (not illustrated). The roller 36 protrudes upward from the upper surface of the case body 31 through a rectangular-shaped opening section 32 formed on the upper surface of the case body 31.

A portion fed from the roller 34 in the wiping member 29 is wound on the roller 36. Thus, a portion of the wiping member 29 which is wound on the roller 36 protrudes upper side from the upper surface of the case body 31. In addition, the uppermost portion of a peripheral surface of the wiping member 29 which is wound on the roller 36 is positioned higher than the lower surface of the liquid ejecting head 21. The entire region of the wiping member 29 in the width direction orthogonal to the feeding direction is exposed from the opening section 32 of the case body 31 to outside the case body 31.

The wiper unit 28 moves the wiper cassette 26 in a direction reverse to the sub-scanning direction Y from a solid line to a position illustrated in a two-dotted chain line in the drawing by moving the wiper holder 27. As a result, the exposed wiping member 29 is moved relatively to the liquid ejecting head 21 as illustrated in a white arrow in the drawing. Then, according to the movement of the wiper holder 27, first, the uppermost portion of the wiping member 29, which is wound on the roller 36, is pressed on each lower surface of the head cover 24 and the liquid ejecting head 21, in other words, on the wiping surface FS by the roller 36. As a result, a substantially rectangular-shaped abutment region WP, of which the longitudinal direction is the axial direction of the roller 36, is formed on the pressed uppermost portion of the wiping member 29. Thus, the wiping member 29 is moved while being pressed on the wiping surface FS and the formed abutment region WP is moved along the wiping surface FS thereby wiping the wiping surface FS. Accordingly, the abutment region WP in the wiping member 29 is also a region coming into contact with the ink when the wiping is performed.

In addition, when the wiping surface FS is wiped by the wiping member 29, the carriage 16 is moved to the home position HP along the guide shaft 15. In addition, as illustrated in FIG. 2, in a state where the wiper cassette 26 is disposed on an initial position of the wiping operation, the head cover 24 (liquid ejecting head 21) is disposed having a distance with the roller 36 in a direction opposite to the sub-scanning direction Y in a state where the carriage 16 is moved to the home position HP.

Next, the wiping surface FS in which the wiping member 29 wipes is described with reference to FIGS. 3A and 3B.

As illustrated in FIGS. 3A and 3B, the head cover 24 provided with respect to the liquid ejecting head 21 is formed from a substantially box-shaped metal plate having a substantially, rectangular-shaped flat plate section 24a having a constant thickness and a side plate section 24b bent at a right angle in each end side of the flat plate section 24a. Then, a plurality (four in the embodiment) of substantially rectangular-shaped through holes H, of which the longitudinal direction is the sub-scanning direction Y and four corners is cut obliquely, is provided on the flat plate section 24a.

Meanwhile, the lower surface (the surface in the gravity direction Z side) of the liquid ejecting head 21 has a nozzle forming surface 21s which is a substantially rectangular-shaped flat surface on which the nozzles 23 are formed. A plurality (four in the embodiment) of nozzle lines NL, on which a plurality of the nozzles 23 are arranged substantially in a line, are disposed on the nozzle forming surface 21s in parallel each other along a direction orthogonal to the main scanning direction X of the carriage 16. Then, the head cover 24 included in the liquid ejecting head 21 is constituted such that the side surface of the liquid ejecting head 21 is covered by the side plate section 24b and the nozzle forming surface 21s of the liquid ejecting head 21. In addition, the nozzle forming surface 21s of the liquid ejecting head 21 is covered so that each of the nozzle lines NL is positioned substantially center of the through holes H provided on the flat plate section 24a.

As a result, the wiping surface FS, which is wiped by the abutment region WP formed on the wiping member 29 included in the wiper unit 28, is constituted of the nozzle forming surface 21s as a first region surface on which the nozzles 23 are formed and the cover surface 24s as a second region that is a surface (an outer surface) of the flat plate section 24a. In other words, in the embodiment, the plurality (four in the embodiment) of the nozzle forming surfaces 21s divided into a region portion corresponding to the through holes H by being covered by the head cover 24 and the cover surface 24s formed to surround a region portion of each of the nozzle forming surfaces 21s which is divided are the wiping surface FS. In addition, the cover surface 24s is a continuous surface having a step KD of a thickness D with respect to the nozzle forming surface 21s. In addition, the cover surface 24s is a convex surface protruding from nozzle forming surface 21s to the wiping member 29 side on which the wiping member 29 abuts when wiping is performed.

Now, in the embodiment, for example, head cover 24 is subjected to lyophilic treatment or a material having lyophile in a state of being untreated state is used and the head cover 24 is formed. Accordingly, the cover surface 24s becomes the wiping surface FS having liquid-repellency to the ink lower than the nozzle forming surface 21s. In addition, the step KD portion is an end surface of the through holes H provided on the flat plate section 24a of the head cover 24 and is a surface having the liquid-repellency the same as the cover surface 24s. Originally, the liquid-repellent treatment is performed on the step KD portion so that the step KD may have the same liquid-repellency as the nozzle forming surface 21s.

Next, operation of the embodiment, in other words, the wiping operation of the wiping member 29 with respect to the wiping surface FS having the step KD is described.

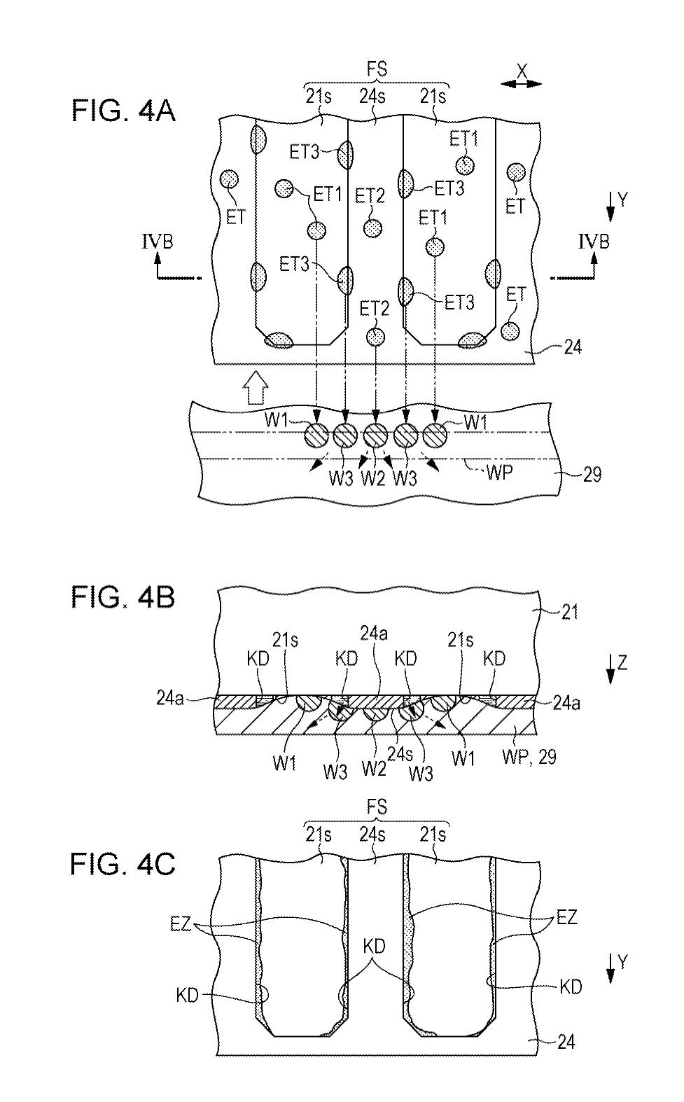

Before that, firstly, in order to facilitate the understanding of the operation of the embodiment, as Comparative Example, the wiping operation of the wiping member 29 is described with reference to FIGS. 4A, 4B and 4C, in a case where the liquid-repellent treatment is performed on the head cover 24 and then the cover surface 24s and the nozzle forming surface 21s have the wiping surfaces FS having the same the liquid-repellency each other. In addition, in FIG. 4B, for ease of explanation, the step KD is illustrated exaggeratingly.

As illustrated in FIGS. 4A and 4B, in a state where the wiping is started by the wiping member 29 (the abutment region WP), the ink (ink mist) ejected from the nozzles 23 is aggregated on the wiping surface FS on which the liquid-repellent treatment is performed by the surface tension. Thus, a plurality of substantially spherical-shaped liquid droplets ET are attached to the step KD portion. In the embodiment, as an example, FIG. 4A illustrates that a plurality of liquid droplets ET1 are attached to the nozzle forming surface 21s, a plurality of liquid droplets ET2 are attached to the cover surface 24s and a plurality of liquid droplets ET3 are attached to the step KD, respectively. In addition, when the liquid droplets are referred collectively without distinguishing between them, they are referred to as the liquid droplets ET. In addition, in order to simplify the description, each of the liquid droplets ET is assumed to have the same amount of the ink.

In such Comparative Example, when the wiping operation is started, the wiping member 29 (the abutment region WP) is moved in a direction opposite the sub-scanning direction Y, as illustrated in a white arrow in the drawing. According to the movement, each liquid droplets ET is absorbed from a contact portion with each abutment region WP into the wiping member 29 due to sequential contact with the abutment region WP. In other words, as illustrated in FIGS. 4A and 4B, the ink of the liquid droplets ET1 attached to the nozzle forming surface 21s is absorbed into an absorption portion W1 in the wiping member 29 and the ink of the liquid droplets ET2 attached to the cover surface 24s is absorbed into an absorption portion W2 in the wiping member 29, respectively. In addition, the ink of the liquid droplets ET3 attached to the step KD portion is absorbed into an absorption portion W3 in the wiping member 29.

Since the step KD portion is formed such that the longitudinal direction thereof is the sub-scanning direction Y, the plurality of the liquid droplets ET3 attached to the step KD portion among the liquid droplets ET come in contact with the abutment region WP which is moved along the sub-scanning direction Y the same as the step KD portion. Accordingly, the absorption portion W3 absorbing the ink of the liquid droplets ET3 is formed on the substantially same position in the wiping member 29. Thus, after the ink of one of the liquid droplets ET3 is absorbed into the absorption portion W3 inside the wiping member 29, next liquid droplet ET3 comes in contact with the wiping member 29 and the absorption portion W3 is formed on the same position, before the ink is diffused and absorbed and then a region range of the absorption portion W3 is spread as illustrated in broken lines in the drawing. As described above, since the ink is absorbed and concentrated on a portion of the moving wiping member 29, the absorption of the ink into the absorption portion W3 formed on the wiping member 29 is not enough. Thus, as illustrated in FIG. 4C, the wiping member 29 remains a residual ink EZ on the step KD portion in the wiping surface FS without absorbing the residual ink EZ.

In addition, about the plurality of liquid droplets ET2 attached to the cover surface 24s, when the liquid droplets ET2 are attached to the portions in which they overlap in the sub-scanning direction Y, similarly, the absorption portion W2 is always positioned substantially the same position in the wiping member 29 which absorbs the ink of the liquid droplets ET2 by coming contact with the abutment region WP moving along the sub-scanning direction Y. As a result, the ink of the plurality of the liquid droplets ET2 is absorbed and concentrated on a portion of the moving wiping member 29. Accordingly, the absorption of the ink into the absorption portion W2 formed on the wiping member 29 is not enough. Thus, the ink is moved to the main scanning direction X that is the longitudinal direction thereof along the abutment region WP, in other words, it is moved to a side where the step KD is positioned. Thus, in the wiping member 29, the absorption portion W2 is formed on a position adjacent the absorption portion W3 or substantially the same position as the absorption portion W3 when the liquid droplets ET2 is moved to the step KD portion. In addition, the absorption portion W2 suppresses the spreading of the absorption portion W3 inside the wiping member 29. Accordingly, the absorption of the ink of the liquid droplets ET3 into the absorption portion W3 is not further enough and then as illustrated in FIG. 4C, the chance that the residual ink EZ is remained on the step KD portion in the wiping surface FS is increased.

In addition, the number of a plurality of the liquid droplets ET1 attached to the nozzle forming surface 21s are the same as the number of a plurality of liquid droplets ET2 attached to the cover surface 24s. In other words, when the plurality of the liquid droplets ET1 is concentrated and comes in contact with a portion of the moving wiping member 29, the absorption of the ink into the absorption portion W1 in the wiping member 29 is not enough. In addition, the ink is moved in the main scanning direction X side that is the longitudinal direction thereof along the abutment region WP, in other words, is moved to a side where the step KD portion is positioned. Thus, the absorption portion W1 is formed on a position adjacent the absorption portion W3 or substantially the same position as the absorption portion W3 when the liquid droplets ET2 is moved to the step KD portion. In addition, the absorption portion W1 suppresses the spreading of the absorption portion W3 inside the wiping member 29. Accordingly, the absorption of the ink of the liquid droplets ET3 into the absorption portion W3 is not great enough and then as illustrated in FIG. 4C, chance that the residual ink EZ is remained on the step KD portion in the wiping surface FS is increased.

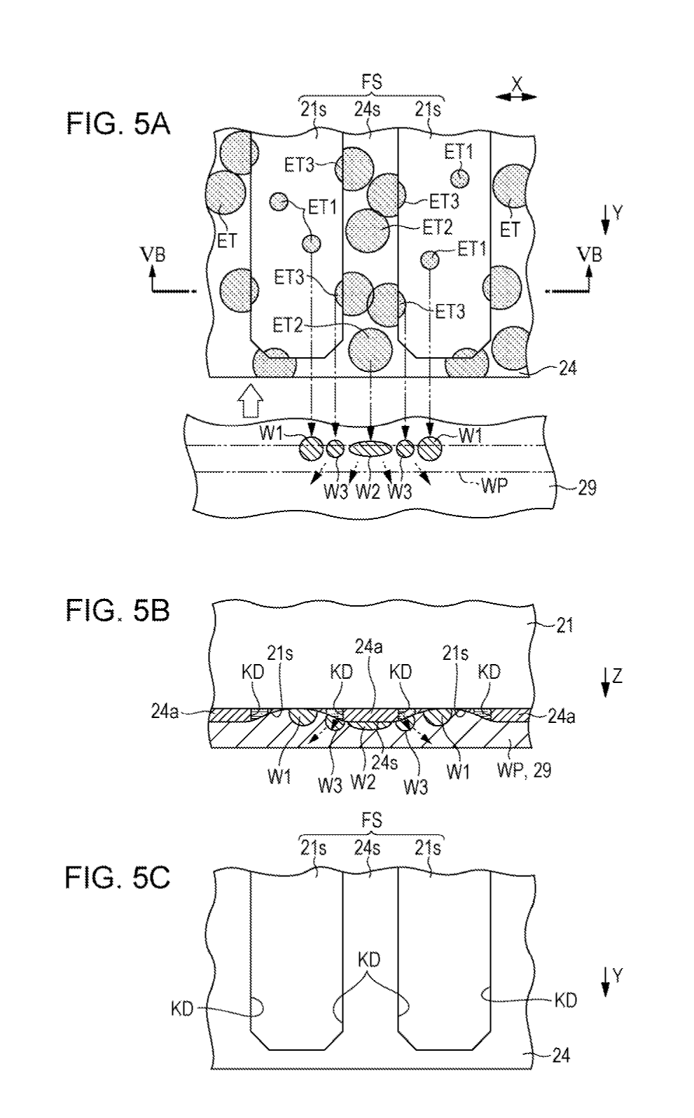

Now, operation of the embodiment, that is, the wiping operation of the wiping member 29 is described with reference to FIGS. 5A, 5B and 5C. In addition, FIGS. 5A, 5B and 5C correspond to FIGS. 4A, 4B and 4C of Comparative Example. In addition, in FIG. 5B, for ease of explanation, the step KD is illustrated exaggeratingly similar to FIG. 4B.

As illustrated in FIGS. 5A and 5B, in a state where the wiping is started by the wiping member 29 (the abutment region WP), the ink (ink mist) ejected from the nozzles 23 is unlikely to be aggregated by the surface tension on the cover surface 24s having the liquid-repellency lower than the nozzle forming surface 21s in wiping surface FS. Although being aggregated, the ink is spread flatly and attached to the cover surface 24s. In order to easily understand the difference from Comparative Example, in the embodiment, as illustrated in FIG. 5A, the description is given in a state where the liquid droplets ET2 attached to the cover surface 24s is spread on the cover surface 24s having low surface tension and in a state where the liquid droplets ET3 attached to the step KD is spread to the cover surface 24s side, which has low surface tension, respectively. In addition, the liquid droplets ET1 attached to the nozzle forming surface 21s is attached as a substantially spherical-shaped liquid droplets, similar to Comparative Example. In addition, when the liquid droplets are referred collectively without any distinction between them, they are referred to as the liquid droplets ET similar to Comparative Example. Each of the liquid droplets ET is assumed to have the same amount of the ink similar to Comparative Example.

Now, in the embodiment, when the wiping operation is started, the wiping member 29 (the abutment region WP) is moved in a direction opposite the sub-scanning direction Y, as illustrated in a white arrow in the drawing. According to the movement, each liquid droplets ET is absorbed from a contact portion with each abutment region WP into the wiping member 29 due to sequential contact with the abutment region WP. In other words, as illustrated in FIGS. 5A and 5B, the ink of the liquid droplets ET1 attached to the nozzle forming surface 21s is absorbed into an absorption portion W1 in the wiping member 29 and the ink of the liquid droplets ET2 attached to the cover surface 24s is absorbed into an absorption portion W2 in the wiping member 29, respectively. In addition, the ink of the liquid droplets ET3 attached to the step KD portion, which is spread to the cover surface 24s, is absorbed into an absorption portion W2 in the wiping member 29 and the ink of the liquid droplets portion remained on the step KD portion is absorbed into the absorption portion W3 in the wiping member 29.

The plurality of the liquid droplets ET3 among the liquid droplets ET, which are attached to the step KD portion, flows out from the step KD portion in such a manner that a portion of the liquid droplets ET3 is spread from the nozzle forming surface 21s to the cover surface 24s side which has relatively low liquid-repellency, even though the absorption portion W3, which comes into contact with the abutment region WP and absorbs the liquid droplets ET3, is always formed on the substantially same position. As a result, the amount of the liquid of the liquid droplets ET3 which is absorbed in the absorption portion W3 in the wiping member 29 is small. Accordingly, even though the plurality of liquid droplets ET3 are concentrated and absorbed into a portion of the wiping member 29, all the liquid droplets ET3 can be absorbed inside the wiping member 29 from the absorption portion W3.

In addition, about a portion of the liquid droplets ET3 introduced from the step KD portion and the plurality of the liquid droplets ET2 attached to the cover surface 24s, each ink is spread to the cover surface 24s. Accordingly, the absorption portion W2, which absorbs the liquid droplets ET2 by coming into contact with the abutment region WP, has a wide region range in the main scanning direction without being concentrated on a place. As a result, the plurality of the liquid droplets ET2 can avoid concentrating in a portion of the moving wiping member 29 even though the plurality of the liquid droplets ET2 are attached to the positions which are overlapped each other on the sub-scanning direction Y. Accordingly, the wiping member 29 absorbs the ink enough.

In addition, similar to Comparative Example, regarding the plurality of the liquid droplets ET1 attached to the nozzle forming surface 21s, when the plurality of the liquid droplets ET1 are concentrated and come in contact with a portion of the moving wiping member 29, the absorption of the ink by the wiping member 29 is not enough. In addition, the ink is moved in the main scanning direction X side that is the longitudinal direction thereof along the abutment region WP, in other words, is moved to a side where the step KD portion is positioned. Thus, in the wiping member 29, the absorption portion W1 is formed on a position adjacent the absorption portion W3. However, in the embodiment, since the amount of the ink of the liquid droplets ET3 absorbed into the absorption portion W3 is small, the absorption of the ink of the liquid droplets ET3 into the absorption portion W3 in the wiping member 29 is not interfered even though the absorption portion W3 is formed adjacent the absorption portion W1.

In addition, the liquid droplets ET1 among the liquid droplets ET1 attached to the nozzle forming surface 21s, which is moved to the step KD, are spread to the cover surface 24s having a low liquid-repellency, without being remained on the step KD portion. Accordingly, when the liquid droplets ET1 are moved to the step KD portion, since the amount of the ink of a portion of the liquid droplets ET1 remained on the substantially same position as the absorption portion W3 is small, the ink may be absorbed into the absorption portion W3 different from Comparative Example. In addition, the residual ink of the liquid droplets ET1, which is further spread to the cover surface 24s, can be also absorbed into the absorption portion W2 in the wiping member 29 similar to the liquid droplets ET2.

As a result, as illustrated in FIG. 5C, the plurality of the liquid droplets ET attached to the wiping surface FS including the step KD portion can be absorbed into the wiping member 29 by the wiping operation of the embodiment without remaining the entire ink different from Comparative Example illustrated in FIG. 4C.

According to the embodiment described above, effects can be obtained as below.

(1) Since the cover surface 24s has a low liquid-repellency, the ink attached to the step KD portion by moving from the nozzle forming surface 21s when the wiping is performed is moved from the nozzle forming surface 21s to on the cover surface 24s without being concentrated and remained on the step KD portion. In addition, the ink attached to on the cover surface 24s including the ink which is moved from the nozzle forming surface 21s side is spread on the entire cover surface 24s without being concentrated on a portion thereof. As a result, in the wiper unit 28, the ink which is spread and attached to the cover surface 24s can be absorbed from the wiping surface FS including the step KD portion of the wiping surface FS without being remained by the wiping member 29 which is moved while wiping the wiping surface FS.

(2) The cover surface 24s is the convex surface protruding from the nozzle forming surface 21s to the wiping member 29 which abuts the cover surface 24s when the wiping is performed. Accordingly, the cover surface 24s is close to the wiping member 29. Thus, when the wiping is performed by the wiping member 29, the cover surface 24s is reliably wiped from the nozzle forming surface 21s by the wiping member 29. Accordingly, the ink attached to the cover surface 24s having a low liquid-repellency including the ink which is moved from the nozzle forming surface 21s can be efficiently absorbed into the wiping member 29.

(3) The cover surface 24s constituting the wiping surface FS is the surface of the head cover 24. Accordingly, the surface of the head cover 24 is a surface having the liquid-repellency lower than the nozzle forming surface 21s so that the cover surface 24s constituting the wiping surface FS can easily be a surface having the liquid-repellency lower than the nozzle forming surface 21s.

(4) The cover surface 24s is formed to surround the nozzle forming surface 21s. Accordingly, the wiper unit 28 can move the ink attached to the nozzle forming surface 21s to the cover surface 24s regardless of the moving direction of the wiping member 29 which is relatively moved.

(5) The wiping member 29 is formed from a fiber-based member. Accordingly, the ink can be absorbed into a space portion having the fiber. Thus, the ink attached to the wiping surface FS including the step KD portion can be efficiently absorbed.

In addition, the above embodiment may be changed to other embodiments described below.

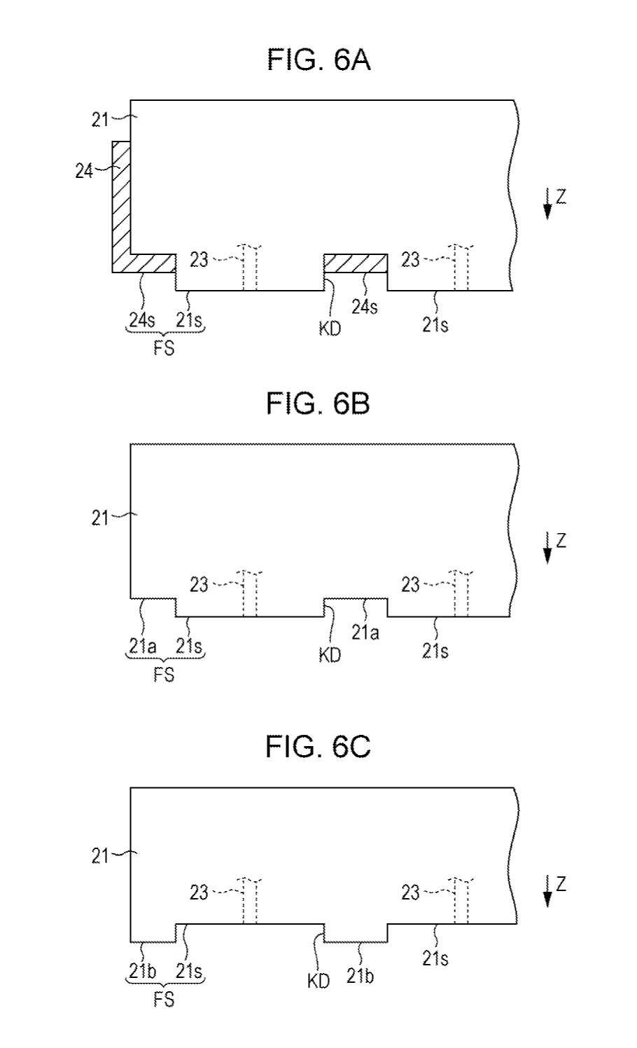

In the above embodiment, it is not essential that the step KD portion is the convex surface such that the cover surface 24s of the head cover 24 protrudes to close to the wiping member 29 side more than the nozzle forming surface 21s when wiping is performed. Modification Example thereof is deformed with reference to FIGS. 6A, 6B and 6C.

As illustrated in FIG. 6A, the step KD may be formed so that the nozzle forming surface 21s protrudes more than the cover surface 24s in the wiping member 29 side, that is, in the gravity direction Z when the wiping is performed. In this case, since the liquid droplets ET (ET3) attached to the step KD portion is moved from the step KD portion in the horizontal direction and is spread to the cover surface 24s, the ink of the liquid droplets ET (ET3) attached to the step KD portion can be easily spread from the nozzle forming surface 21s side to on the cover surface 24s.

In addition, as illustrated in FIG. 6B, the step KD portion may be formed so that a concave surface 21a, which is concave on the opposite side to the nozzle forming surface 21s in the gravity direction Z, is provided in liquid ejecting head 21. When the head cover 24 is not provided on the liquid ejecting head 21, such a step KD may be formed. In addition, in this case, for example, the concave surface 21a can easily be a surface having the liquid-repellency lower than the nozzle forming surface 21s by performing the liquid-repellent treatment on the nozzle forming surface 21s using a dipping treatment in which only the protruded nozzle forming surface 21s is immerged in a liquid-repellent agent.

Otherwise, as illustrated in FIG. 6C, the step KD portion may be formed in the liquid ejecting head 21 so that a convex surface 21b, protruding from the nozzle forming surface 21s in the gravity direction Z side. Similarly, when the head cover 24 is not provided on the liquid ejecting head 21, such a step KD may be formed. In this case, for example, the convex surface 21b can easily be a surface having the liquid-repellency lower than the nozzle forming surface 21s by performing the liquid-repellent treatment on the nozzle forming surface 21s using a depositing treatment to deposit the liquid-repellent agent in which only the protruding convex surface 21b is masked.

In the above embodiment, the wiping member 29 may not necessarily be formed from a fiber-based member. For example, the wiping member 29 may be a member which is formed from a porous material such as sponge. In short, any member may be used if the member is capable of absorbing the liquid (the ink) and abutting the wiping surface FS.

In the above embodiment, the cover surface 24s may not necessarily be formed to surround the nozzle forming surface 21s. For example, in the above embodiment, in the cover surface 24s, at least one side surface of both sides may be removed with respect to the nozzle forming surface 21s in the sub-scanning direction Y. In other words, in the above embodiment, even though the cover surface 24s is removed in the opposite side to the sub-scanning direction Y, the wiping member 29 is protected by the head cover 24 in the wiping start side.

In the above embodiment, the second region surface constituting the wiping surface FS may not necessarily be the cover surface 24s of the head cover 24. For example, the nozzle forming surface 21s is constituted to be covered by a member different from the head cover 24 and the different member may be the second region surface.

In the above embodiment, the number of the ink cartridge 22 is not limited to four and may be greater or less than four. In addition, in the printer 11, the liquid ejecting head 21 may eject the ink onto the paper P at a fixed position without moving in the main scanning direction X necessarily. In addition, in this case, the wiper unit 28 may be moved on the main scanning direction X.

In the embodiment described above, the liquid ejecting apparatus may be embodied as a liquid ejecting apparatus ejecting or discharging liquid other than the ink. In addition, a state of the liquid ejected as the liquid droplets of small amount from the liquid ejecting apparatus also includes liquids trailing in granular shape, a tear shape and a thread shape. In addition, the liquid referred to herein may be a material which can be ejected from the liquid ejecting apparatus. For example, a material may be used as long as the material is in the state of the liquid phase. In addition, the material includes liquid material having high or low viscosity, a flow-shape body such as sol, gel water, inorganic solvent, organic solvent, solution, liquid-shaped resin, liquid-shaped metal (melt metal). In addition, the liquid as one state of a material includes a material in which particles of functional material consisted of solids such as pigments or metal particles is dissolved, dispersed or mixed in a solvent. In addition, a representative example of the liquid includes the ink described in the above embodiment, liquid crystal or the like. Here, the ink is intended to include various types of liquid compositions such as general water-based ink, oil-based ink, gel ink and hot melt ink. A specific example of the liquid ejecting apparatus includes, for example, a liquid ejecting apparatus ejecting liquid including in a form of dispersed or dissolved material such as color material or electrode material that is used to manufacture a liquid crystal display, an EL (electroluminescence) display, a surface emitting display and color filter. In addition, the liquid ejecting apparatus may be a liquid ejecting apparatus ejecting a bioorganic material used for biochip manufacturing, a liquid ejecting apparatus ejecting liquid which is a sample used as a precision pipette, a printing apparatus, a micro-dispenser or the like. Furthermore, the liquid ejecting apparatus may employ a liquid ejecting apparatus ejecting lubricant at pin point to a precision machine such as a watch or a camera, a liquid ejecting apparatus ejecting transparent liquid such as an ultraviolet curing resin to form micro hemispherical lens (an optical lens) used for an optical communication device or the like on a substrate. In addition, the liquid ejecting apparatus may employ a liquid ejecting apparatus ejecting etching liquid such as acid or alkali to etch a substrate or the like.

What is claimed is:

1. A liquid ejecting apparatus comprising:
a liquid ejecting head on which a liquid ejecting nozzle is provided; and
a wiping section which wipes the liquid ejecting head by relative moving a liquid absorption body which absorbs the liquid while abutting the liquid absorption body to the liquid ejecting head,
wherein the liquid ejecting head has a surface constituted of first region surface on which the nozzle is formed and a second region surface which is continuous to the first region surface with a step, as a wiping surface which is wiped by the wiping section, and
wherein on the wiping surface, the second region surface is a surface having lower liquid-repellency, than the first region surface with respect to the liquid.

2. The liquid ejecting apparatus according to claim 1,
wherein the second region surface is a concave surface which protrudes from the first region surface to the liquid absorption body side abutting when the wiping is performed.

3. The liquid ejecting apparatus according to claim 1, further comprising:
a head cover which covers at least a portion of the wiping surface of the liquid ejecting head,
wherein the second region surface constituting the wiping surface is a surface of the head cover.

4. The liquid ejecting apparatus according to claim 1,
wherein the second region surface is formed so as to surround the first region surface.

5. The liquid ejecting apparatus according to claim 1,
wherein the liquid absorption body is formed of a fiber-based member.
